(19) United States
(12) Patent Application Publication
(10) Pub. No.: US 2026/0160604 A1
(43) Pub. Date: Jun. 11, 2026

(54) TEMPERATURE SENSOR

(71) Applicants: YAZAKI CORPORATION, Tokyo (JP); TOYOTA JIDOSHA KABUSHIKI KAISHA, Aichi-Ken (JP)

(72) Inventors: Hiraku TANAKA, Shizuoka (JP); Kenta TANAKA, Shizuoka (JP); Kaname HATANO, Aichi (JP)

(73) Assignees: YAZAKI CORPORATION, Tokyo (JP); TOYOTA JIDOSHA KABUSHIKI KAISHA, Aichi-Ken (JP)

(21) Appl. No.: 19/349,146

(22) Filed: Oct. 3, 2025

(30) Foreign Application Priority Data
Oct. 7, 2024 (JP) 2024-176068

(51) Int. Cl. G01K 1/14; G01K 1/08

(52) U.S. Cl. CPC G01K 1/14; G01K 1/08

(57) ABSTRACT

A temperature sensor is attached to a predetermined attachment object. The temperature sensor includes a temperature measuring element, an accommodating body in which the temperature measuring element is embedded and accommodated, and a housing that stores the accommodating body therein. The accommodating body is a die-molded article having a predetermined molded shape. The housing includes an insertion portion to be inserted into a hole of the attachment object, and an opening portion provided in the insertion portion and opened to expose at least a part of the accommodating body.

### CROSS-REFERENCE TO RELATED APPLICATIONS

This application is based on and claims priority under 35 USC 119 from Japanese Patent Application No. 2024-176068 filed on Oct. 7, 2024, the contents of which are incorporated herein by reference.

### TECHNICAL FIELD

The present invention relates to a temperature sensor including a temperature measuring element, an accommodating body in which the temperature measuring element is embedded and accommodated, and a housing that stores the accommodating body therein.

### BACKGROUND ART

In the related art, temperature sensors for measuring temperatures of various objects to be measured (for example, a gas and a liquid) have been proposed. For example, one of the temperature sensors in the related art has a built-in thermistor for temperature measurement, and is attached to an in-vehicle pipe to measure a temperature of a fluid flowing in the in-vehicle pipe (for example, see Patent Literature 1).

### CITATION LIST

### Patent Literature

Patent Literature 1: JP2014-160023A

### SUMMARY OF INVENTION

### Technical Problem

In general, a thermistor generally used in the above-described types of temperature sensors is configured to cover a temperature measuring element with a film made of resin or the like in order to protect the temperature measuring element and to protect a contact portion between the temperature measuring element and an electric wire. As a method of forming a resin film, generally, a method (so-called a fluidized-bed coating method) is exemplified in which a temperature measuring element to which an electric wire is connected is immersed in a molten resin liquid and then drawn out from the resin liquid, so that the resin liquid is collected in the temperature measuring element or a contact portion and then the resin liquid is cured. However, with this method, a shape, a thickness, or the like of the resin film is less likely to be controlled, and thus the variation in the shape or the like of the film may occur for each product. Such variation in the shape or the like of the film may affect the temperature measurement performance of the temperature sensor.

One object of the present invention is to provide a temperature sensor with excellent temperature measurement performance.

### Solution to Problem

In order to achieve the above object, the temperature sensor according to the present invention is characterized as follows.

The temperature sensor is attached to a predetermined attachment object. The temperature sensor includes a temperature measuring element, an accommodating body in which the temperature measuring element is embedded and accommodated, and a housing that stores the accommodating body therein. The accommodating body is a die-molded article having a predetermined molded shape. The housing includes an insertion portion to be inserted into a hole of the attachment object, and an opening portion provided in the insertion portion and opened to expose at least a part of the accommodating body.

### Advantageous Effects of Invention

According to the temperature sensor of the present invention, the accommodating body in which the temperature measuring element is embedded is the die-molded article having a predetermined molded shape. In other words, the accommodating body is not molded by using a fluidized-bed coating method in the related art, but is molded using a die designed to have the predetermined molded shape. Accordingly, the variation in the shape of the accommodating body is reduced as compared with the prior art. Therefore, for example, the accommodating body can be accurately formed so as to have a shape suitable for temperature measurement corresponding to a gas, a liquid, or the like to be measured. Furthermore, the housing includes the opening portion that is opened so as to expose at least a part of the accommodating body, and thus the gas, the liquid, or the like to be measured can be brought into direct contact with the accommodating body through the opening portion. In this way, the accommodating body is a die-molded article, and at least a part of the accommodating body is exposed to the opening portion of the housing, and thus it is possible to improve the temperature measurement performance, such as responsiveness of the temperature sensor. Therefore, the temperature sensor of the present invention has excellent temperature measurement performance.

The present invention is briefly described above. Further, details of the present invention will be clarified by reading modes for carrying out the invention described below with reference to the accompanying drawings.

### BRIEF DESCRIPTION OF DRAWINGS

FIG. 1 is a perspective view illustrating a temperature sensor and an attachment object having an attachment hole according to an embodiment of the present invention;

FIG. 2 is a perspective view illustrating a thermistor stored inside the temperature sensor illustrated in FIG. 1;

FIG. 3 is a perspective view of the temperature sensor illustrated in FIG. 1 viewed from another angle;

FIG. 4 is a front view of the temperature sensor illustrated in FIG. 1, which is attached to an attachment hole of an attachment object;

FIG. 5 is a rear view of the temperature sensor illustrated in FIG. 1, which is attached to the attachment hole of the attachment object;

FIG. 6 is a cross-sectional view taken along a line A-A in FIG. 4; and

FIG. 7 is a cross-sectional view taken along a line B-B in FIG. 5.

### DESCRIPTION OF EMBODIMENTS

### Embodiment

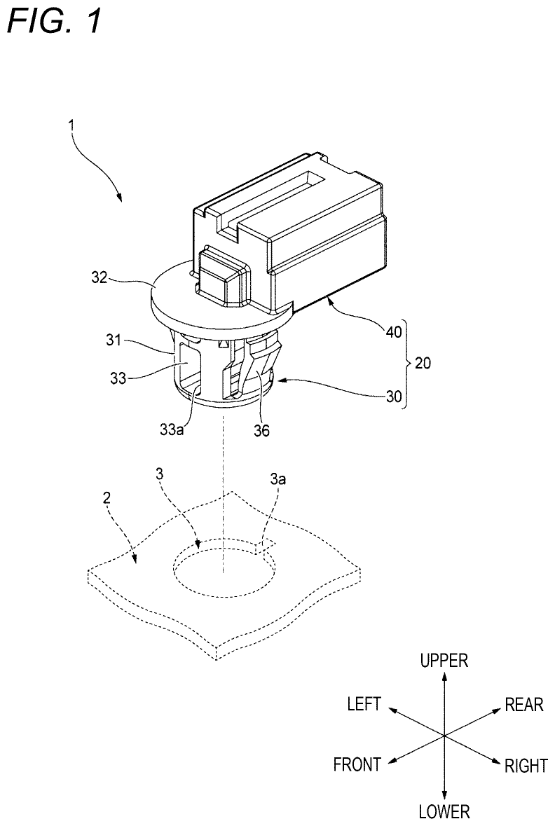

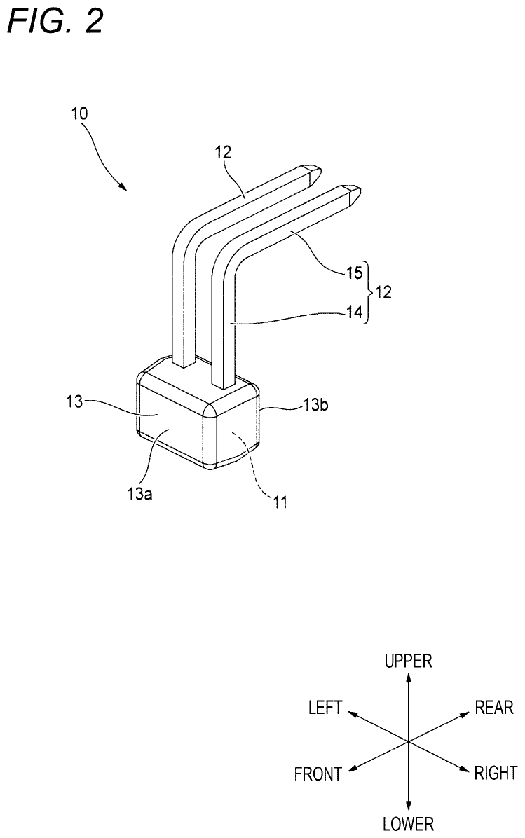

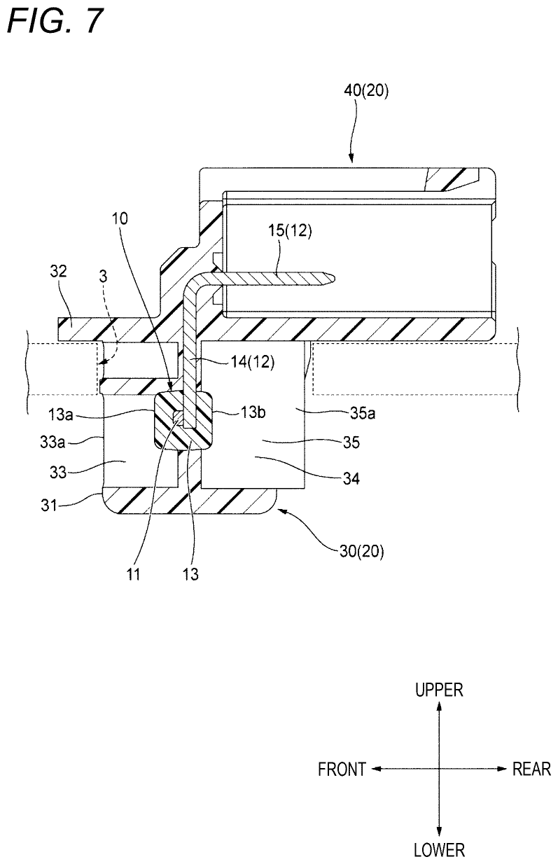

Hereinafter, a temperature sensor 1 according to an embodiment of the present invention will be described with reference to the drawings. The temperature sensor 1 illustrated in FIG. 1 is used, for example, in a state of being inserted into and fixed to an attachment hole 3 of an attachment object 2. The attachment object 2 is, for example, a wall that defines an intake passage through which the air passes to cool a high-voltage battery installed in a vehicle or the like, and in this case, the temperature sensor 1 attached to the attachment object 2 functions to measure a temperature of the air flowing through the intake passage. The temperature sensor 1 includes a thermistor 10 (see FIGS. 2 and 7) and a housing 20 (see FIG. 1 and the like) that stores the thermistor 10 therein.

Hereinafter, for convenience of description, “front”, “rear”, “left”, “right”, “upper”, and “lower” are defined as illustrated in FIG. 1. A “front-rear direction”, a “left-right direction”, and an “upper-lower direction” are orthogonal to one another. The front-rear direction, the left-right direction, and the upper-lower direction do not necessarily have to coincide with a front-rear direction, a left-right direction, and an upper-lower direction of the vehicle or the like on which the temperature sensor 1 is mounted. Hereinafter, the components constituting the temperature sensor 1 will be described in order.

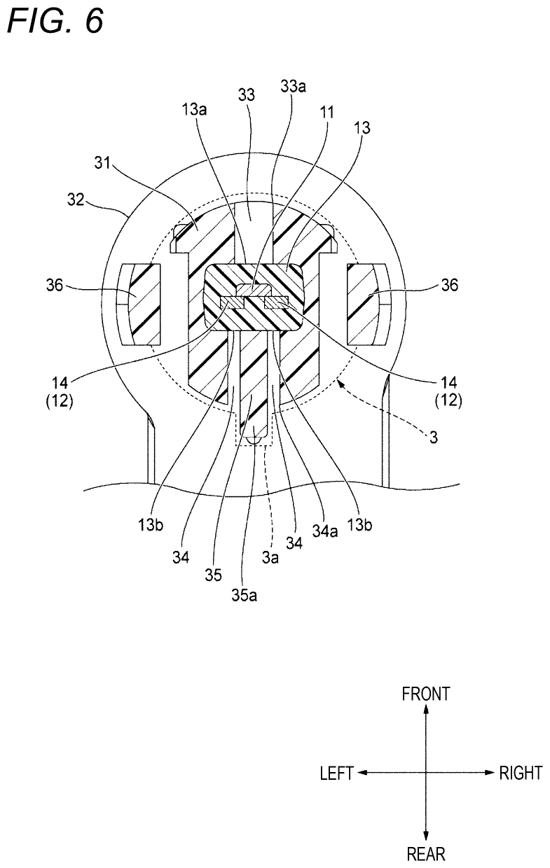

First, the thermistor 10 will be described. As illustrated in FIGS. 6 and 7, and the like, the thermistor 10 is integrated into the resin housing 20 by insert molding so as to be stored (embedded) inside the housing 20. As illustrated in FIGS. 2, 6, and 7, the thermistor 10 includes a thermistor element 11, a pair of rod-shaped metal terminals 12 extending from the thermistor element 11, and a resin accommodating body 13 that accommodates the thermistor element 11 such that the entire thermistor element 11 is embedded therein.

As illustrated in FIG. 2, each of the pair of terminals 12 includes a first portion 14 extending linearly upward from the thermistor element 11 and a second portion 15 extending linearly rearward from an upper end portion of the first portion 14, and has an L-shape when viewed from the left-right direction. The pair of terminals 12 are arranged side by side with intervals in the left-right direction.

The resin accommodating body 13 is a die-molded article having a substantially rectangular parallelepiped molded shape. In other words, the accommodating body 13 is molded using a die so as to have a previously designed molded shape. Accordingly, the variation in the shape of the accommodating body 13 is reduced. The accommodating body 13 has a substantially rectangular parallelepiped molded shape having an outer surface constituted by six surfaces. In general, in the accommodating body having such a shape, when a work tool or the like is brought into contact with a boundary or the like between adjacent surfaces, there is a concern that deformation or the like of the accommodating body may occur due to stress concentration in the contact portion or the like. However, in the temperature sensor 1, the accommodating body 13 is stored inside the housing 20, and thus even though the accommodating body 13 has such a molded shape, the deformation or the like of the accommodating body 13 can be appropriately reduced.

Next, the housing 20 will be described. The housing 20 is a resin molded article, and as illustrated in FIGS. 1 and 7, and the like, the housing 20 includes a body portion 30 and a connector portion 40, which are integrally formed. As can be seen from FIG. 7, and the like, the thermistor 10 is embedded inside the housing 20 such that a part of the accommodating body 13 is exposed at the body portion 30, and the second portions 15 of the pair of terminals 12 are exposed at the connector portion 40.

As illustrated in FIG. 1, the body portion 30 includes an insertion portion 31 having a substantially cylindrical shape extending in the upper-lower direction, and a flange portion 32 that extends radially outward from an upper end portion of the insertion portion 31 around an entire circumferential area of the insertion portion 31. The insertion portion 31 is a portion to be inserted into the attachment hole 3 of the attachment object 2. Therefore, a side face of the insertion portion 31 has an outer peripheral shape corresponding to the attachment hole 3 (see FIG. 1 and the like) of the attachment object 2.

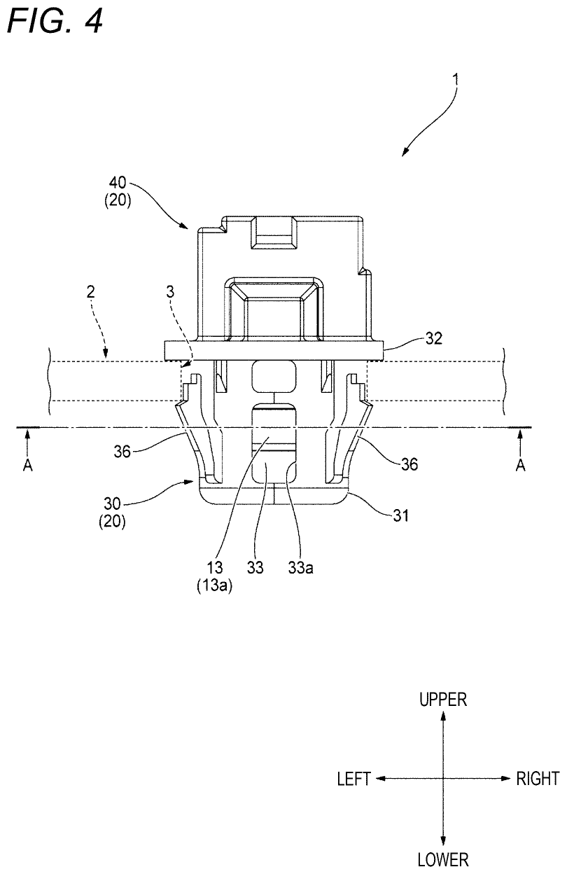

As illustrated in FIG. 1 and the like, a first opening portion 33 is formed in a front end portion of the side face of the insertion portion 31. The first opening portion 33 is a recess recessed rearward from a rectangular first opening 33a located at the front end portion of the side face of the insertion portion 31 toward the accommodating body 13 of the thermistor 10 embedded inside the body portion 30 (see FIGS. 6 and 7). By forming the first opening portion 33, a part of a front face 13a (see FIG. 2 and the like) of the accommodating body 13 of the thermistor 10 is exposed to an outside through the first opening 33a (see FIG. 4). The rectangular first opening 33a has a size that does not allow a work tool or a user's finger to insert therein.

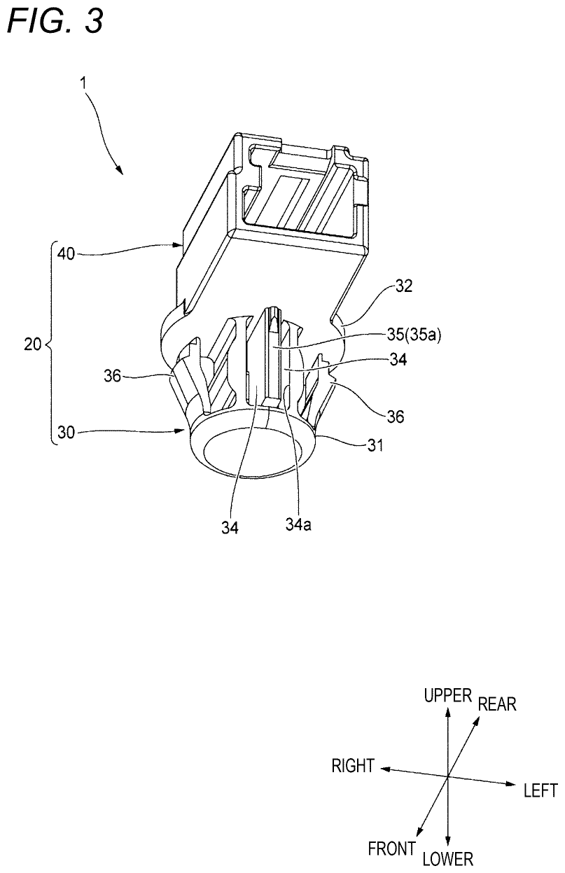

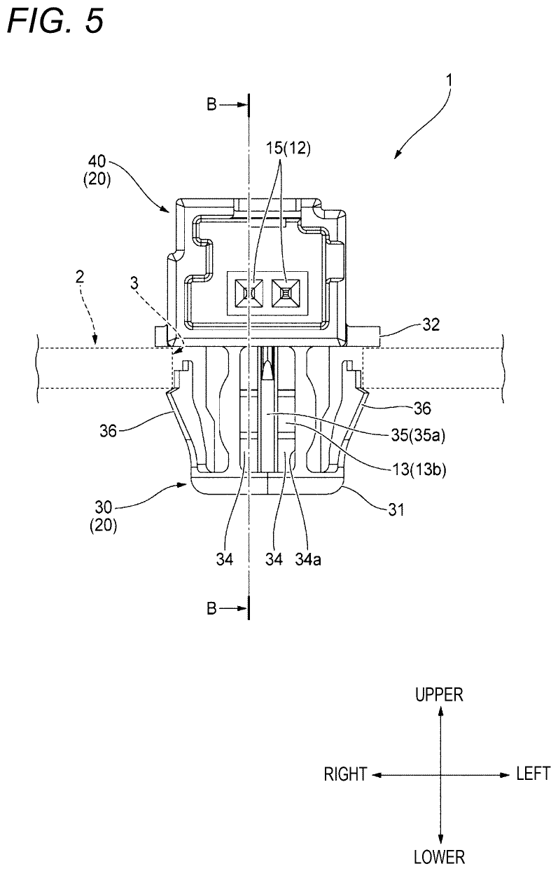

As illustrated in FIG. 3 and the like, a second opening portion 34 is formed in a rear end portion of the side face of the insertion portion 31. The second opening portion 34 is a recess recessed forward from a rectangular second opening 34a located at the rear end portion of the side face of the insertion portion 31 toward the accommodating body 13 of the thermistor 10 embedded inside the body portion 30 (see FIGS. 6 and 7). By forming the second opening portion 34, a part of a rear face 13b (see FIG. 2 and the like) of the accommodating body 13 of the thermistor 10 is exposed to an outside through the second opening 34a (see FIG. 5).

The second opening portion 34 is provided with a partition wall 35 extending in the front-rear direction from inside to outside of the second opening portion 34 so as to divide an internal space extending in the front-rear direction of the second opening portion 34 into two parts in the left-right direction (into left and right small regions) (see FIGS. 3 and 6). The partition wall 35 continuously extends in the front-rear direction from a position of the rear face 13b of the accommodating body 13 of the thermistor 10 embedded inside the body portion 30 to a position behind the rear end portion of the side face of the insertion portion 31. A portion of the partition wall 35 that protrudes further rearward from the rear end portion of the side face of the insertion portion 31 functions as an engagement portion 35a that is engaged with an engagement recess 3a (see FIG. 1) provided on a rear edge portion of the attachment hole 3 of the attachment object 2. Each of left and right openings in which the rectangular second opening 34a is partitioned by the partition wall 35 has a size that does not allow a work tool or a user's finger to insert therein.

A pair of left and right locking pieces 36 are provided on both left and right end portions of the side face of the insertion portion 31. Each of the locking pieces 36 is an elastic piece extending upward in a cantilever shape from a lower portion of the side face of the insertion portion 31, and is elastically deformable in a radial direction of the insertion portion 31. The pair of left and right locking pieces 36 are engaged with the edge portion of the attachment hole 3 of the attachment object 2 (see FIGS. 4 and 5).

Specifically, as illustrated in FIGS. 1 and 3, the connector portion 40 has a substantially rectangular box-shaped hood shape extending so as to protrude rearward from an upper portion of the body portion 30, and a rear end of the connector portion 40 is opened. As illustrated in FIG. 7, the second portions 15 of the pair of terminals 12 of the thermistor 10 protrude rearward from an inner wall (front end wall) of the connector portion 40 within the connector portion 40. The second portions 15 of the pair of terminals 12 located inside the connector portion 40 are exposed to an outside through rear end openings of the connector portion 40 (see FIG. 7). The connector portion 40 is to be connected to a counterpart connector (not illustrated) provided at an end of an electric wire extending from a temperature detection device (not illustrated). When the counterpart connector is connected to the connector portion 40, an electrical signal output from the thermistor element 11 (signal indicating a temperature around the thermistor element 11) is input to the temperature detection device, which can detect the temperature around the thermistor element 11. The components constituting the temperature sensor 1 have been described above.

As illustrated in FIG. 1, the temperature sensor 1 having the above configuration is used in a state in which the insertion portion 31 of the body portion 30 is inserted into the attachment hole 3 of the attachment object 2 from an upper side such that the engagement portion 35a of the partition wall 35 is accommodated in the engagement recess 3a of the attachment hole 3. In a state in which the insertion of the temperature sensor 1 (insertion portion 31) into the attachment hole 3 is completed, the pair of left and right locking pieces 36 are engaged with the edge portion of the attachment hole 3 such that the pair of left and right locking pieces 36 and the flange portion 32 of the body portion 30 sandwich the edge portion of the attachment hole 3 (see FIGS. 4 and 5 and the like). Accordingly, the temperature sensor 1 is prevented from coming off (separating) from the attachment object 2. The engagement portion 35a of the partition wall 35 is accommodated in the engagement recess 3a of the attachment hole 3. Accordingly, the temperature sensor 1 is prevented from being displaced in a rotational manner within the attachment hole 3, and thus an orientation of the temperature sensor 1 with respect to the attachment object 2 can be maintained in a desired orientation.

### Operations and Effects

As described above, according to the temperature sensor 1 of the present embodiment, the accommodating body 13 in which the temperature measuring element (thermistor element 11) is embedded and accommodated is a die-molded article having a predetermined molded shape (substantially rectangular parallelepiped shape). In other words, the accommodating body 13 is not molded by using a fluidized-bed coating method in the related art, but is molded using a die designed to have a predetermined molded shape. Accordingly, the variation in the shape of the accommodating body 13 is reduced as compared with the prior art. Furthermore, by providing, in the housing 20, the opening portion (first opening portion 33 and second opening portion 34) that is opened such that at least a part (front face 13a and rear face 13b) of the accommodating body 13 is exposed, a liquid to be measured in temperature or the like can be brought into direct contact with the accommodating body 13 through the opening portion (first opening portion 33 and second opening portion 34). Accordingly, the temperature measurement performance, such as responsiveness of the temperature sensor 1, can be improved. Therefore, the temperature sensor 1 according to the present embodiment has excellent temperature measurement performance.

Furthermore, according to the temperature sensor 1 of the present embodiment, the partition wall 35 is provided to partition the opening portion 34 of the housing 20. When an opening region of the second opening portion 34 is partitioned into a plurality of small regions, it is possible to prevent the work tool, a finger of a worker, a peripheral member, and the like from erroneously inserting into the second opening portion 34. Further, the partition wall 35 includes the engagement portion 35a that is engaged with the hole edge portion of the hole (attachment hole 3) of the attachment object 2. Accordingly, the temperature sensor 1 is prevented from being displaced in a rotational manner within the hole 3, and the partition wall 35 also serves as the engagement portion 35a, thereby preventing the housing 20 from becoming large. Furthermore, by preventing the rotation of the temperature sensor 1, damage to the electric wire due to the rotation of the temperature sensor 1 is less likely to occur, and workability of the worker in attaching and detaching the temperature sensor 1 is also improved.

Furthermore, according to the temperature sensor 1 of the present embodiment, the accommodating body 13 has a molded shape having an outer surface constituted by a plurality of surfaces (six surfaces). Such a molded shape is a general shape of the die-molded article. In this case, for example, when the work tool or the like comes into contact with the boundary or the like between the adjacent surfaces, the deformation or the like of the accommodating body 13 may occur. However, the accommodating body 13 is stored inside the housing 20, and thus even though the accommodating body 13 has such a molded shape, the deformation or the like of the accommodating body 13 can be appropriately reduced.

### Other Embodiments

The present invention is not limited to the embodiment described above, and various modifications can be adopted within the scope of the present invention. For example, the present invention is not limited to the embodiment described above, and modifications, improvements, and the like can be appropriately made. In addition, materials, shapes, sizes, numbers, arrangement positions, and the like of components in the embodiment described above are freely selected and are not limited as long as the present invention can be implemented.

Here, features of the embodiment of the temperature sensor 1 according to the present invention described above are briefly summarized and listed in the following [1] to [3].
[1] A temperature sensor (1) including: a temperature measuring element (11); an accommodating body (13) in which the temperature measuring element (11) is embedded and accommodated; and a housing (20) configured to store the accommodating body (13) therein, the temperature sensor (1) being attached to a predetermined attachment object (2), in which
the accommodating body (13) is a die-molded article having a predetermined molded shape, and
the housing (20) includes an insertion portion (31) to be inserted into a hole (3) of the attachment object (2), and an opening portion (33, 34) provided in the insertion portion (31) and opened to expose at least a part of the accommodating body (13).

According to the temperature sensor having the configuration of [1], the accommodating body in which the temperature measuring element is embedded is the die-molded article having a predetermined molded shape. In other words, the accommodating body is not molded by using a fluidized-bed coating method in the related art, but is molded using a die designed to have the predetermined molded shape. Accordingly, the variation in the shape of the accommodating body is reduced as compared with the prior art. Therefore, for example, the accommodating body can be accurately formed so as to have a shape suitable for temperature measurement corresponding to a gas, a liquid, or the like to be measured. Furthermore, the housing includes the opening portion that is opened so as to expose at least a part of the accommodating body, and thus the gas, the liquid, or the like to be measured can be brought into direct contact with the accommodating body through the opening portion. In this way, the accommodating body is a die-molded article, and at least a part of the accommodating body is exposed to the opening portion of the housing, and thus it is possible to improve the temperature measurement performance, such as responsiveness of the temperature sensor. Therefore, the temperature sensor of this configuration has excellent temperature measurement performance.
[2] The temperature sensor (1) according to [1], in which
the housing (20) includes a partition wall (35) extending from inside to outside of the opening portion (34) so as to partition an opening region of the opening portion (34) into a plurality of small regions, and
the partition wall (35) includes an engagement portion (35a) to be engaged with a hole edge portion of the hole (3).

According to the temperature sensor having the configuration of [2], the partition wall is provided to partition the opening portion of the housing. When an opening region of the opening portion is partitioned into a plurality of small regions, it is possible to prevent a work tool, a finger of a worker, a peripheral member, and the like from erroneously inserting into the opening portion. Further, the partition wall includes the engagement portion that is engaged with the hole edge portion of the hole of the attachment object. Accordingly, the temperature sensor is prevented from being displaced in a rotational manner within the hole, and the partition wall also serves as the engagement portion, thereby preventing the housing from becoming large. Furthermore, by preventing the rotation of the temperature sensor, damage to the electric wire due to the rotation of the temperature sensor is less likely to occur, and workability of the worker in attaching and detaching the temperature sensor is also improved.
[3] The temperature sensor (1) according to [1], in which
the molded shape of the accommodating body (13) is a shape having an outer surface constituted by a plurality of surfaces.

According to the temperature sensor having the configuration of [3], the accommodating body has a molded shape having an outer surface constituted by a plurality of surfaces. In this case, for example, when the work tool or the like comes into contact with the boundary or the like between the adjacent surfaces, stress concentration occurs in the contact portion, and thus the deformation or the like of the accommodating body may occur. However, the accommodating body is stored inside the housing, and thus even though the accommodating body has such a molded shape, the deformation or the like of the accommodating body can be appropriately reduced.

What is claimed is:

1. A temperature sensor attached to a predetermined attachment object, the temperature sensor comprising:
a temperature measuring element;
an accommodating body in which the temperature measuring element is embedded and accommodated; and
a housing that stores the accommodating body therein, wherein
the accommodating body is a die-molded article having a predetermined molded shape, and
the housing includes an insertion portion to be inserted into a hole of the attachment object, and an opening portion provided in the insertion portion and opened to expose at least a part of the accommodating body.

2. The temperature sensor according to claim 1, wherein
the housing includes a partition wall extending from inside to outside of the opening portion so as to partition an opening region of the opening portion into a plurality of small regions, and
the partition wall includes an engagement portion to be engaged with a hole edge portion of the hole.

3. The temperature sensor according to claim 1, wherein
the molded shape of the accommodating body is a shape having an outer surface constituted by a plurality of surfaces.
